(19) United States
(12) Patent Application Publication
(10) Pub. No.: US 2012/0155873 A1
(43) Pub. Date: Jun. 21, 2012

(54) POWER SAVING APPARATUS AND METHOD FOR OPTICAL LINE TERMINAL AND OPTICAL NETWORK UNIT

(75) Inventors: Han-Hyub LEE, Daejeon-si (KR); Sang-Soo Lee, Daejeon-si (KR)

(73) Assignee: ELECTRONICS AND TELECOMMUNICATIONS RESEARCH INSTITUTE, Daejeon-si (KR)

(21) Appl. No.: 13/307,105

(22) Filed: Nov. 30, 2011

(30) Foreign Application Priority Data
Dec. 15, 2010 (KR) 10-2010-0128368
May 20, 2011 (KR) 10-2011-0048067

(51) Int. Cl. H04B 10/20

(52) U.S. Cl. 398/58

(57) ABSTRACT

A power saving apparatus for an optical line terminal (OLT) and an optical network unit (ONU) is provided. The power saving apparatus includes a determination unit configured to determine whether a data traffic is generated between the ONU and a customer premises equipment (CPE), and a control unit configured to perform control such that each of the OLT and the ONU are converted to a power saving mode if a result of the determination is that a data traffic is not generated.

### CROSS-REFERENCE TO RELATED APPLICATION

This application claims the benefit under 35 U.S.C. §119(a) of Korean Patent Applications No. 10-2010-0128368, filed on Dec. 15, 2010, and No. 10-2011-0048067, filed on May 20, 2011, the disclosures of which are incorporated by reference in its entirety for all purposes.

### BACKGROUND

1. Field

The following description relates to a technology capable of saving power consumption of an optical line terminal (OLT) and an optical network unit (ONU).

2. Description of the Related Art

A FTTH (Fiber To The Home) technology is to provide a required frequency band to a subscriber, and has a Point-to-Point architecture or a Point-to-Multipoint architecture. An optical line terminal (OLT) has an interface capable of supporting multiple optical network units (ONU), and has a control over all of the ONUs. In general, the Point-to-Point architecture is used for an Active Optical Network (AON), and the Point-to-Multipoint architecture is used for a Passive Optical Network. The Point-to-Point architecture and the Point-to-Multipoint architecture are under standardization by standards organizations, such as IEEE and ITU-T.

A communication network system has been propagated rapidly to home and office, requiring effective power consumption. Not only in the communication network system but in an optical access network, effective power consumption is highly regarded In general, the power of the OLT and the ONU, which form the optical access network, is turned on 24 hours of 356 days. However, since the operation time using the OLT and ONU in practice is about 20% of 24 hours, a great amount of power is wasted.

Accordingly, there is a need for a study and technology to save power consumption.

### SUMMARY

The following description relates to a power saving apparatus and a power saving method capable of reducing power consumption by converting an optical line terminal (OLT) and an optical network unit (ONU) to a power saving mode when data traffic is not generated between the ONU and a premises equipment (PE).

In one general aspect, there is provided a power saving apparatus for an optical line terminal (OLT) and an optical network unit (ONU), the power saving apparatus including: a determination unit configured to determine whether a data traffic is generated between the ONU and a customer premises equipment (CPE); and a control unit configured to perform control such that each of the OLT and the ONU are converted to a power saving mode if a result of the determination is that a data traffic is not generated.

If a result of the determination is that a data traffic is not generated, the control unit may transmit a conversion message for power saving mode to the OLT such that the OLT is converted to a power saving mode.

After each of the OLT and the ONU is converted to a power saving mode, if a result of the determination is that a data traffic is generated, the control unit may perform control such that each of the OLT and the ONU is converted to a normal mode.

If a result of the determination is that a data traffic is generated, the control unit may transmit a conversation message for normal mode to the OLT such that the OLT is converted to a normal mode.

After each of the OLT and the ONU is converted to the power saving mode, the control unit may allow the OLT and the ONU to exchange information about a current operation mode between each other at a predetermined period of time.

In another general aspect, there is provided a power saving method for an optical line terminal (OLT) and an optical network unit (ONU), the power saving method including: at a determination unit, determining whether a data traffic is generated between the ONU and a customer premises equipment (CPE); and at a control unit, performing control such that each of the OLT and the ONU is converted to a power saving mode if a result of the determination is that a data traffic is not generated.

The performing of control may include: if a result of the determination is that a data traffic is not generated, transmitting a conversion message for power saving mode to the OLT such that the OLT is converted to a power saving mode.

The performing of a control operation may include: after each of the OLT and the ONU is converted to a power saving mode, if a result of the determination is that a data traffic is generated, performing control such that each of the OLT and the ONU is converted to a normal mode.

The performing of a control operation may include: if a result of the determination is that a data traffic is generated, transmitting a conversation message for normal mode to the OLT such that the OLT is converted to a normal mode.

The performing of control may include: after each of the OLT and the ONU is converted to a power saving mode, allowing the OLT and the ONU to exchange information about a current operation mode between each other at a predetermined period of time.

As described above, when a data traffic is not generated between an optical network unit (ONU) and a customer premises equipment (CPE), the OLT and the ONU are converted to a power saving mode, thereby reducing the power consumption

The OLT and the ONU are controlled to exchange information about a current operation mode between each other at a predetermined period of time, thereby checking the current operation mode of each other.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating the configuration of an example of a power saving system in a wavelength division multiplexing passive optical network (WDM-PON).

FIGS. 2A and 2B are flowcharts illustrating the control flow of an example of a power saving method for an optical line terminal (OLT) and an optical network unit (ONU).

FIG. 3 is a diagram illustrating an example of the amount of power consumption of a power saving apparatus.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

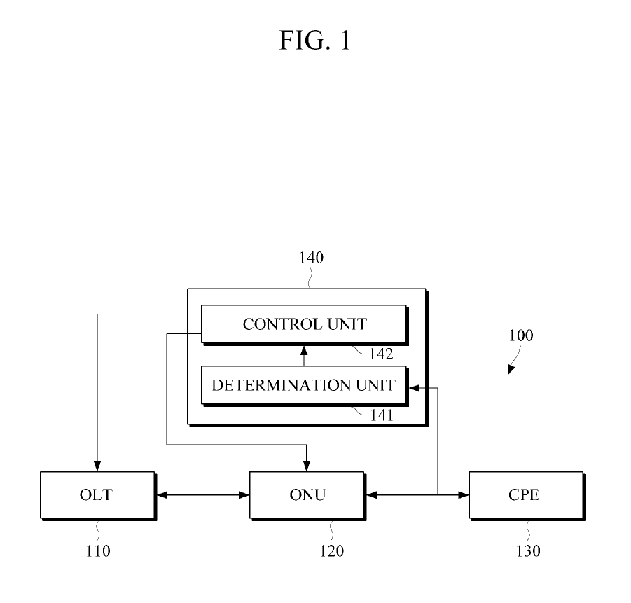

FIG. 1 is a diagram illustrating the configuration of an example of a power saving system in a wavelength division multiplexing passive optical network (WDM-PON).

As shown in FIG. 1, a power saving system 100 includes an optical line terminal (OLT) 110, an optical network unit (ONU) 120, a customer premises equipment (CPE) 130 and a power saving apparatus 140.

The following description will be made in relation that each of the ONU 120 and the power saving apparatus 140 is implemented as a separate module. However, according to another example, the power saving apparatus 140 may be implemented inside the ONU 120.

The OLT 110 serves as a part forming a FTTH (Fiber To The Home), and represents an end point device of a service provider. Also, the OLT 110 serves as a multiservice device to connect a FTTH to another system, and includes a service interface and protocol processing (SIPP) device, a community antenna or access television (CATV) device, a transport device, a network management device, etc. The OLT 110 provides multimedia connection services, including a channel associated signalling (CAS) in a public switched telephone network (PSTN) and an Integrated Services Digital Network (ISDN), a connection to a local exchange of a common channel signalling (CCSS),, an interface in a Packet Switched Public Data Network (PSPDN), a connection to a head end in a CATV network, and an asynchronous transfer mode (ATM) and a broadband service connection, such as internet in a broadband network.

The ONU 120 represents an end point device that is installed at a side of a subscriber to have an access to an FTTH. The ONU 120 establishes a connection to an optical fiber network by use of a communication interface, such as user-network interface of a Narrowband Integrated Services Digital Network (N-ISDN) and user-network interface of a Broadband Integrated Services Digital Network (B-ISDN), or a video signal interface.

The customer premises equipment 130 is a device that is directly used by a user. For example, the customer premise equipment 130 may represent a personal computer.

The power saving apparatus 140 may include a determination unit 141 and a control unit 142.

The determination unit 141 determines whether a data traffic is generated between the ONU 120 and the CPE 130. Accordingly, the determination unit 141 determines whether data transmission or data reception is achieved between the OLT 120 and the CPE 130.

The control unit 142 controls operation modes of the OLT 110 and the ONU 120 according to a result of the determination of the determination unit 141. For example, the operation mode includes a normal mode and a power saving mode. The normal mode indicates that a device performs a normal operation, such as a control operation or a data transmission/reception. The power saving mode indicates that a device only performs a required minimum operation, such as a supervision or control on a uplink/downlink interface, and cuts off power required for other functions.

First, it is assumed that each of the OLT 110 and the ONU 120 operates in a normal mode.

If it is determined that a data traffic is not generated, the control unit 142 performs control such that each of the OLT 110 and the ONU 120 is converted to a power saving mode. For example, if it is determined that a data traffic is not generated, the control unit 142 sends the ONU 120 a control signal that is used to convert to a power saving mode. Upon reception of the control signal, the ONU 120 converts its operation mode to a power saving mode. In addition, if it is determined that a data traffic is not generated, the control unit 142 sends the OLT 110 a conversion message for power saving mode. Upon reception of the conversion message for power saving mode, the OLT 110 converts its operation mode to a power saving mode.

If it is determined that a data traffic is generated, the control unit 142 controls such that the OLT 110 and the ONUT 120 maintain their operation modes of normal modes.

After each of the OLT 110 and the ONU 120 is converted to a power saving mode, if a result of the determination by the determination unit 141 is that a data traffic is generated, the control unit 142 performs a control operation such that each of the OLT 110 and the ONU 120 is converted to a normal mode. For example, if it is determined that a data traffic is generated, the control unit 142 may send the ONU 120 a control signal, which is used to convert to a normal mode. Upon reception of the control signal, the ONU 120 converts its operation mode to a normal mode. If it is determined that a data traffic is generated, the control unit 142 sends the OLT 110 a conversion message for normal mode. Upon reception of the conversion message for normal mode, the OLT 110 converts its operation mode to a normal mode.

After each of the OLT 110 and the ONU 120 is converted to the power saving mode, the control unit 142 allows the OLT 110 and the ONU 120 to exchange information about a current operation mode between each other at a predetermined period of time. The information about the current operation mode represents information indicating whether a current operation mode is a power saving mode or a normal mode. For example, the control unit 142 may perform control such that the OLT 110 transmits information about a current operation mode at a period of time of 20 ms. In addition, the control unit 142 may perform control such that the ONU 120 transmits information about a current operation mode at a period of time of 20 ms. In this manner, the OLT 110 and the ONU 120 check the current operation mode of each other.

Unlike the above description, the power saving apparatus 140 may be included in the ONU 120.

According to this example of the power saving apparatus, when a data traffic is not generated between the OLT 110 and the ONU 120, the OLT 110 and the ONU 120 convert their operation modes to power saving modes, thereby reducing their power consumption.

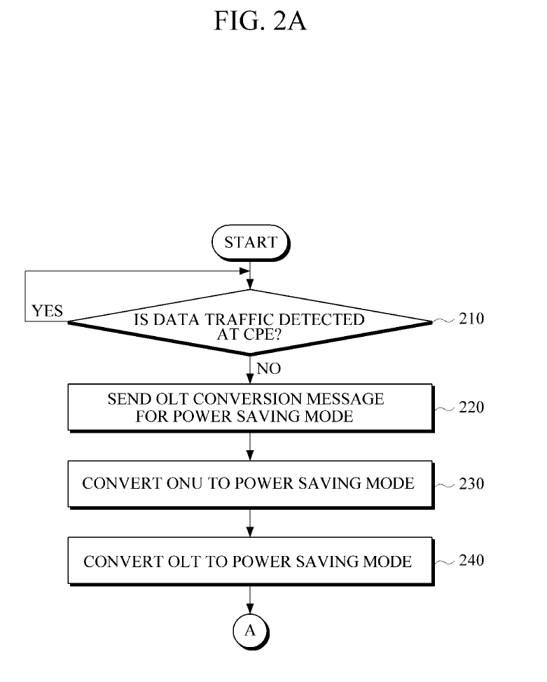

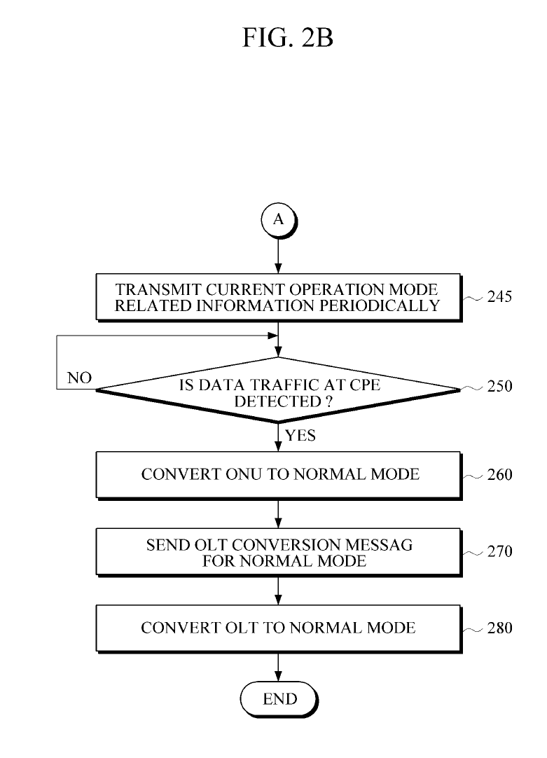

FIGS. 2A and 2B are flowcharts illustrating the control flow of an example of a power saving method for an optical line terminal (OLT) and an optical network unit (ONU).

As shown in FIGS. 1, 2A and 2B, each of the OLT and the ONU operate in a normal mode. The determination unit 141 determines whether a data traffic is generated between the ONU 120 and the CPE 130 (210). If it is determined that a data traffic is generated, the control unit 143 allows each of the OLT 110 and the ONU 120 to maintain a normal mode.

Meanwhile, if it is determined that a data traffic is not generated, the control unit 142 sends the OLT 110 a conversion message for power saving mode (220). The control unit 142 performs control such that the ONU 120 is converted to a power saving mode (230). The control performs control such that the OLT 110 is converted to a power saving mode (240).

After each of the OLT 110 and the ONU 120 is converted to the power saving mode, the control unit 142 allows the OLT 110 and the ONU 120 to exchange information about a current operation mode between each other at a predetermined period of time (245). For example, the control unit 142 may perform control such that the OLT 110 transmits information about a current operation mode at a period of time of 20 ms. In addition, the control unit 142 may perform control such that the ONU 120 transmits information about a current operation mode at a period of time of 20 ms. In this manner, the OLT 110 and the ONU 120 checks the current operation mode of each other.

The determination unit 141 determines whether a data traffic is generated between the ONU 120 and the CPE 130 (250). If it is determined that a data traffic is not generated, the control unit 142 performs control such that each of the OLT 110 and the ONU 120 operates in a power saving mode.

Meanwhile, if it is determined that a data traffic is generated, the control unit 142 performs control such that the ONU 120 is converted to a normal mode (260). The control unit 142 sends the OLT 110 a conversion message for normal mode (270). Upon reception of the conversion message, the OLT 110 converts its operation mode to a normal mode (280).

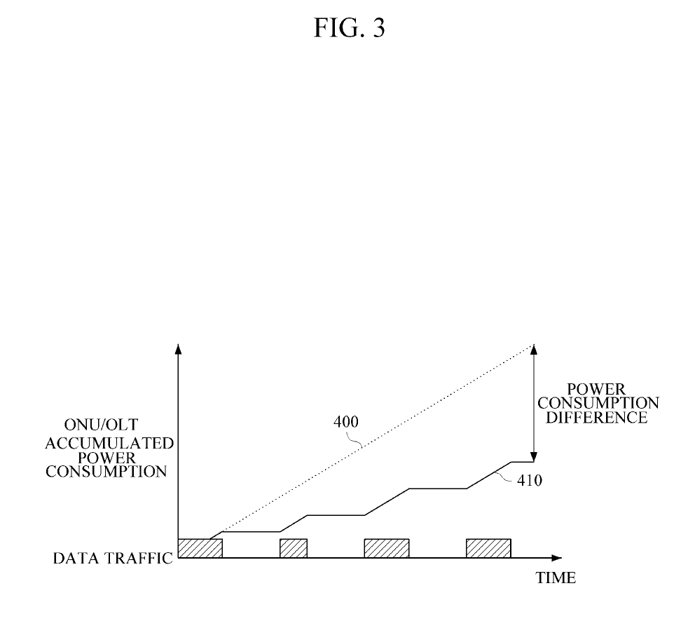

FIG. 3 is a diagram illustrating an example of the amount of power consumption of a power saving apparatus.

As shown in FIG. 3, in a case when a power saving apparatus is not used, power consumption (400 of FIG. 3) is continuously increased.

Meanwhile, in a case when a power saving apparatus is used, power consumption (410 of FIG. 3) is significantly reduced compared to the power consumption (400 of FIG. 3) obtained when a power saving apparatus is not used.

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A power saving apparatus for an optical line terminal (OLT) and an optical network unit (ONU), the power saving apparatus comprising:
a determination unit configured to determine whether a data traffic is generated between the ONU and a customer premises equipment (CPE); and
a control unit configured to perform control such that each of the OLT and the ONU are converted to a power saving mode if a result of the determination is that a data traffic is not generated.

2. The power saving apparatus of claim 1, wherein if a result of the determination is that a data traffic is not generated, the control unit transmits a conversion message for power saving mode to the OLT such that the OLT is converted to a power saving mode.

3. The power saving apparatus of claim 1, wherein after each of the OLT and the ONU is converted to a power saving mode, if a result of the determination is that a data traffic is generated, the control unit performs control such that each of the OLT and the ONU is converted to a normal mode.

4. The power saving apparatus of claim 3, wherein if a result of the determination is that a data traffic is generated, the control unit transmits a conversation message for normal mode to the OLT such that the OLT is converted to a normal mode.

5. The power saving apparatus of claim 1, wherein after each of the OLT and the ONU is converted to the power saving mode, the control unit allows the OLT and the ONU to exchange information about a current operation mode between each other at a predetermined period of time.

6. A power saving method for an optical line terminal (OLT) and an optical network unit (ONU), the power saving method comprising:
at a determination unit, determining whether a data traffic is generated between the ONU and a customer premises equipment (CPE); and
at a control unit, performing control such that each of the OLT and the ONU is converted to a power saving mode if a result of the determination is that a data traffic is not generated.

7. The power saving method of claim 6, wherein the performing of control comprises:
if a result of the determination is that a data traffic is not generated, transmitting a conversion message for power saving mode to the OLT such that the OLT is converted to a power saving mode.

8. The power saving method of claim 6, wherein the performing of a control operation comprises:
after each of the OLT and the ONU is converted to a power saving mode, if a result of the determination is that a data traffic is generated, performing control such that each of the OLT and the ONU is converted to a normal mode.

9. The power saving method of claim 8, wherein the performing of a control operation comprises:
if a result of the determination is that a data traffic is generated, transmitting a conversation message for normal mode to the OLT such that the OLT is converted to a normal mode.

10. The power saving method of claim 6, wherein the performing of control comprises:
after each of the OLT and the ONU is converted to a power saving mode, allowing the OLT and the ONU to exchange information about a current operation mode between each other at a predetermined period of time.
